(19) United States
(12) Patent Application Publication
(10) Pub. No.: US 2022/0277408 A1
(43) Pub. Date: Sep. 1, 2022

(54) System and method for the collection of United States of America nationwide building code for all jurisdictions having authority to adopt and enforce building code for the determination of the jurisdiction with authority for building code adoption and enforcement at the location of real property and the supplying of the building code for real property to the user

(71) Applicant: Garrett John Kurtt, Englewood, CO (US)

(72) Inventor: Garrett John Kurtt, Englewood, CO (US)

(21) Appl. No.: 17/803,323

(22) Filed: May 11, 2022

Related U.S. Application Data
(63) Continuation-in-part of application No. 16/364,082, filed on Mar. 25, 2019, now abandoned.

(51) Int. Cl. G06Q 50/16

(52) U.S. Cl. CPC G06Q 50/163; G06Q 50/165

(57) ABSTRACT

An application, implemented by a computer that compiles real property addresses and then determines which municipality or special district has jurisdiction over a particular real property address for the adoption, governing, control, and enforcement of the adopted building codes and issuance of building permits, and provides the said building codes and authority to issue permits from a proprietary national Master Database, where the building codes are stored once collected, that is monitored to ensure that any changes or new adoptions of building code or building permit authority are updated. This system will provide the end user with instant, accurate information regarding the applicable building codes that have been adopted at a particular real property address including whether the address is regulated by a special district, such as a coastal commission or an Extra-Territorial Jurisdiction

### RELATED PATENT APPLICATIONS

This application is a continuation-in-part of co-pending U.S. patent application Ser. No. 16/364,082 filed Mar. 25, 2019. This related patent application is incorporated herein by reference as if restated in its entirety. This Continuation-in-Part application claims the priority dates of the related patent applications.

### FIELD OF THE INVENTION

The present invention relates to the field of real property development and restoration. More specifically, the invention provides real-time determination of the municipality with jurisdictional authority for the adoption of building codes and the enforcement of said building codes through the issuance of building permits at an address within the United States. This invention relates to the fields of construction design, physical construction, insurance underwriting, and claims evaluation.

### BACKGROUND OF THE INVENTION

Regarding the discussion of the prior art, U.S. Pat. No. 20150332419 by Budlong discloses an invention that facilitates zoning and/or land-use development code impacts on a site selection search or specified location providing instant information about current and hypothetical building mass and use potential.

Prior artwork has focused on providing information in relation to zoning codes and does not provide any information in relation to building codes and/or building permits. Zoning codes, zoning permits and the municipal authority that enforces the zoning code and issues any zoning permits are separate and different from building codes, building permits and the municipal authority that enforces the building code and issues any building permits. Zoning codes and their related zoning permits are focused on the type of structures that can be built in a given location, in addition to how that structure interrelates with the land it is or will be built on. While building codes and their related building permits deal with the structure itself, its physical features and how these qualities impact safety and accessibility. In other words, zoning codes relate to what kind of structure can be built while building codes relate to how that structure must be built.

In addition, the municipality that enforces the zoning code and issues zoning permits is not always the same as the municipality that enforces the building code and issues any building permits. Many municipalities have zoning codes but defer any building code authority to another municipality. For example, the City of Chesterfield, Mo., a municipality within St. Louis County, Mo., enforces zoning codes through the issuance of zoning permits within Chesterfield's municipal boundaries, yet building codes and their enforcement through the issuance of building permits for structures within Chesterfield are under the authority of St. Louis County. Furthermore, the City of Ballwin, Mo., a neighboring municipality to the City of Chesterfield and also within St. Louis County, has authority over zoning codes as well as having elected to have authority over building codes through the issuance of building permits within its municipal boundaries.

Such unobvious and unique municipal relationships are commonplace throughout the tens of thousands of municipalities in the United States. Moreover, even if the appropriate jurisdictions a specific property resides in are known, discerning which jurisdiction has authority over building codes and the issuance of building permits is difficult. Jurisdictional boundaries are invisible and not always in relation to natural or man-made features. In addition, a U.S. Postal Service address by default includes a city name, regardless of whether the physical location of that specified property is within the municipal boundaries of said city name. Thus, relying on a U.S. Postal Service address to determine which jurisdiction a property is within is problematic. Furthermore, roughly 40% of residential properties in the U.S. reside within unincorporated counties and not within the boundaries of an incorporated city yet still have a city name assigned to their U.S. Postal Service address highlighting further the commonality of erroneous city names on U.S. Postal Service addresses.

The inventor is not aware of any independent or third-party services that employ a geospatial database in concert with a database of national building codes and building code authorities, whereby a geospatial database determines the jurisdictions a specific property address resides and a database of national building codes and building code authorities utilizes the geospatial information to then determine building permit issuance authority as well as particular building codes.

The following exemplifies the inefficiencies of the traditional method of determining building codes and building permit authority. First assume a residential property is having their roof replaced. This roof is to be replaced by a contractor and will be covered by the residential property owner's insurance company. The city name on the U.S. Postal Service address for the residential property displays a city name. The contractor and homeowner assume that the residential property is thus within the municipal jurisdiction of the city name on the U.S. Postal Service address. The contractor contacts this city and establishes their appropriate building codes related to roofing and replaces the roof accordingly. Upon completion of the project the homeowner submits their insurance claim to their insurance company for payment reimbursement. Upon receipt of the claim the insurance company comes to believe that the property is under the jurisdiction of a different municipal authority than the contractor. Upon inspection of the work rendered, the insurance company does not reimburse the homeowner since the contractor did not replace the roof according to the building codes of the municipality that the insurance company believes has jurisdictional authority.

The present invention overcomes the inability to easily determine which jurisdiction, or jurisdictions, a specific property resides, but also, which of those jurisdictions has the authority to adopt building codes and enforce said building codes through the issuance of building permits. Subsequently, the present invention serves as data manipulation and retrieval tool that transforms publicly available building code data from cities and counties into a more user-friendly structure in order to catalog and display what the particular building codes are for the previously determined authority having building code jurisdiction.

### SUMMARY OF THE INVENTION

Building regulations have been around in various forms since antiquity. In the United States, major cities began to adopt and enforce building codes near the end of the 19^{th} century. Initially intended to reduce the threat of fire in large urban areas, over time, the scope of building regulations has expanded to address areas such as structural integrity, ventilation, and appropriate construction materials with the main purpose being to protect public health, safety, and general welfare as they relate to the construction and occupancy of buildings.

Today, building codes are a set of rules that specify minimum standards for the construction of buildings and other structures. To be constructed and/or repaired, buildings must conform to the specified code to obtain a building permit. The issuer of a building permit is typically the state or local government where the building does or will reside. Although not themselves legally binding, building code does become law for a particular jurisdiction when formally adopted by the appropriate governmental authority. Today, the vast majority of communities within the United States have formally adopted building codes and have a system in place for building regulation through the issuance of building permits.

Given the thousands of cities, towns, townships, boroughs, counties, etc. that make up the United States, deciphering which municipality has the authority to issue a building permit as well as what building codes are adopted can be daunting. Municipalities can overlap one another and cross county boundaries. Simply using the common city name or zip code provided from a given United States Postal Service address many times does not provide the correct information regarding the government entity that has the authority to issue building permits or what the adopted building codes are. In other instances, a particular municipality may contract out their building department services to the county it resides in, to a private institution, or to another municipality entirely.

The inventor is not aware of any independent or third-party services that employ a geospatial database in concert with a database of national building codes and building code authorities, whereby a geospatial database determines the jurisdictions a specific property address resides and a database of national building codes and building code authorities utilizes the geospatial information to then determine building permit issuance authority as well as particular building codes. In addition, prior reviewed art does not utilize the same non-geospatial database and does not provide the same detail relating to building codes and municipal authorities that issue building permits.

The present invention solves the burdensome task of finding the appropriate governmental authority that adopts and enforces the local building code, issues building permits, as well as what are the specific adopted building codes. The invention involves a system comprised of computer software and databases that work in concert to deliver accurate, site-specific, building code and contact information as United States Postal Service addresses are not always accurate when determining in which municipality a real property is located.

This invention allows the user to easily access the adopted building code and jurisdictional building contact information. This allows participants in the system, including federal, state, and local government officials, building contractors, building subcontractors, property insurance underwriters, property insurance actuaries, property insurance adjusters, building property owners, design professionals, architects, engineers, and construction professionals to save time and money as they do not have to search for the appropriate building authority and building code. The system determines the municipal jurisdiction with the authority to adopt code, enforce code, and issue building permits and then provides this information along with the adopted building code within a comprehensive code report in real-time.

This invention will have an impact on protecting classes of entities and persons from negligence, misrepresentation, and fraud as the program will simplify the process by which a general contractor, real property owner, insurance company, design professional, or buyer of the home may determine, based upon a property's location, which municipality within the state in which the real property is located has the jurisdictional authority to adopt building codes, enforce building codes, and to issue building permits. The method and system of evaluating in which municipality real property is located and, taking this information and determining which jurisdiction has the authority to adopt building codes and which building codes the jurisdiction has adopted results in a standardized system producing accurate, real time building code information to the end user thus solving the problem regarding whether or not a jurisdiction has adopted building codes and what building code has been adopted, and therefore, enforced by the jurisdiction.

The invention includes a system that begins with a user inputting the street address of a real property. Using commercially available third-party databases and Global Positioning System technology, the provided street address is geocoded, or geo-positionally defined by geographical latitude and longitude coordinates. These coordinates are then plotted against available census data in the form of shapefiles that represent all the known legal boundaries of municipalities throughout the United States. In the United States, each physical street address resides within a particular state and county. Furthermore, each address can fall within a smaller subdivision of a county, in addition to an incorporated city or town.

Utilizing a point-in-polygon algorithm, the system identifies all relative jurisdictions that the street address resides in. In other words, the system provides the state, county, and potential further areas (i.e., county subdivision or city) that contain the street address. All jurisdictions within the census data are provided with a FIPS (Federal Information Processing Standard), MCD (Minor Civil Division) code, Census County Divisions (CCD) code, or an Unorganized Territory (UT) code containing a unique number combination, collectively termed a geographical identification.

Based on locational logic, the legal status, and municipal deference for each of the municipalities that contain the given property address, starting smallest (city, town, etc.) and moving up through the larger jurisdictions (consolidated city, county subdivision, county then state), each respective municipality is correlated to a master database via each municipalities geographical identification where the municipality having final authority is determined and the appropriate building code is retrieved and displayed.

The following exemplifies the inefficiencies of the traditional method of determining building codes and the building permit authority. First assume a residential property is having their roof replaced. This roof is to be replaced by a contractor and will be covered by the residential property owner's insurance company. The city name on the United States Postal Service address for the residential property displays a city name. The contractor and homeowner assume that the residential property is thus within the municipal jurisdiction of the city name on the United States Postal Service address. The contractor contacts this city and establishes their appropriate building codes related to roofing and replaces the roof accordingly. Upon completion of the project the homeowner submits their insurance claim to their insurance company for payment reimbursement. Upon receipt of the claim the insurance company comes to believe that the property is under the jurisdiction of a different municipal authority than the contractor. Upon inspection of the work rendered, the insurance company does not reimburse the homeowner since the contractor did not replace the roof according to the building codes of the municipality that the insurance company believes has jurisdictional authority.

The present invention overcomes the inability to easily determine which jurisdiction, or jurisdictions, a specific property resides, but also, which of those jurisdictions has the authority to adopt building codes and enforce said building codes through the issuance of building permits.

### BRIEF DESCRIPTION OF THE DRAWINGS

FIG. 1A is a screenshot of a map displaying neighboring municipal boundaries and two separate properties, Property A and Property B.

FIG. 1B is a screenshot comparing reports for Property A and Property B from FIG. 1A generated by the invention.

FIG. 2A is a screenshot of a map displaying neighboring municipal boundaries and two separate properties, Property A and Property B.

FIG. 2B is a screenshot comparing reports for Property A and Property B from FIG. 2A generated by the invention.

FIG. 3A is a screenshot of a map displaying the legal municipal boundaries of a city as well as the Extra-Territorial Jurisdictional (ETJ) boundaries of the city and two separate properties, Property A and Property B.

FIG. 3B is a screenshot comparing reports for Property A and Property B from FIG. 3A generated by the invention.

FIG. 4A is a screenshot of a map displaying the municipal boundary of a city that resides in two different counties and two separate properties, Property A and Property B.

FIG. 4B is a screenshot comparing reports for Property A and Property B from FIG. 4A generated by the invention.

FIG. 5A is a screenshot of a map displaying residential properties, represented as points, within county boundaries drawn with a black line.

FIG. 5B is a screenshot of the map from FIG. 5A that includes the addition of county subdivision boundaries drawn with a black line.

FIG. 5C is a screenshot of the map from FIG. 5B that includes the addition of city boundaries drawn with a black line.

FIG. 5D is a screenshot of the map from FIG. 5C that includes the addition of Extra-Territorial Jurisdiction boundaries and special district boundaries drawn with a black line.

FIG. 6 is a view of the types of structured data within the database.

FIG. 7 is a broad overview of the steps taken to determine jurisdiction having authority and combine that with a master database of building codes in order to create a report output.

### DETAILED DESCRIPTION OF THE INVENTION

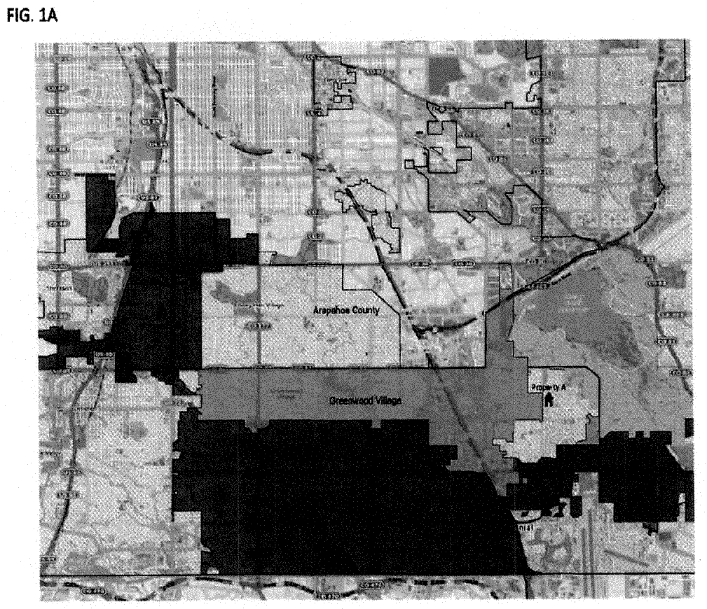

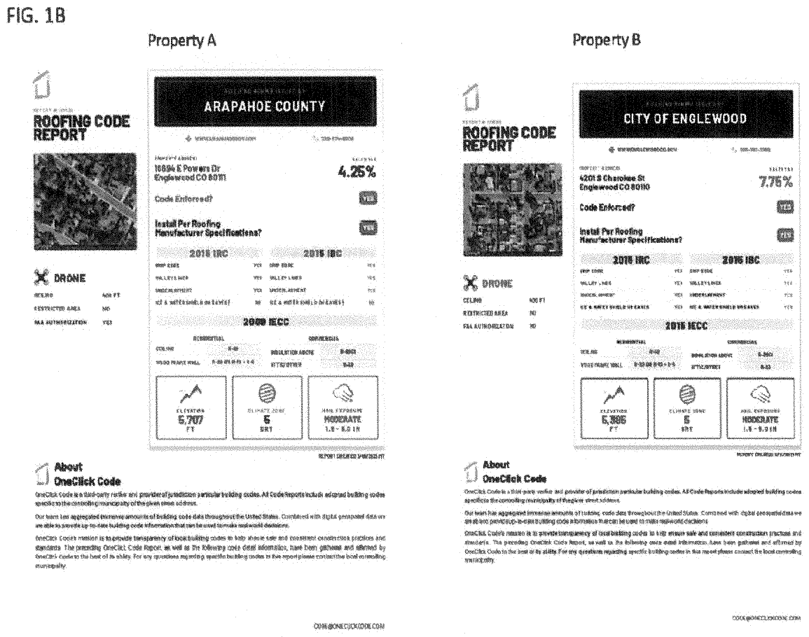

Referring to FIG. 1A, Property A has a U.S. Postal Service address of “10694 E Powers Dr, Englewood, Colo. 80111”. The assigned city for this property is “Englewood” when the property itself is located in unincorporated Arapahoe County. Property B has a U.S. Postal Service address of “4201 S Cherokee St, Englewood, Colo. 80110” and is actually located within the City of Englewood, Colo. The present invention is able to discern that although the U.S. Postal Service for Property A shows Englewood, Colo. it is in fact in unincorporated Arapahoe County.

Referring to FIG. 1B, a screenshot of the output of the present invention showing the differences in building codes between Property B in Englewood, Colo. and Property A in unincorporated Arapahoe County even though the U.S. Postal Service address for each property shows Englewood, Colo.

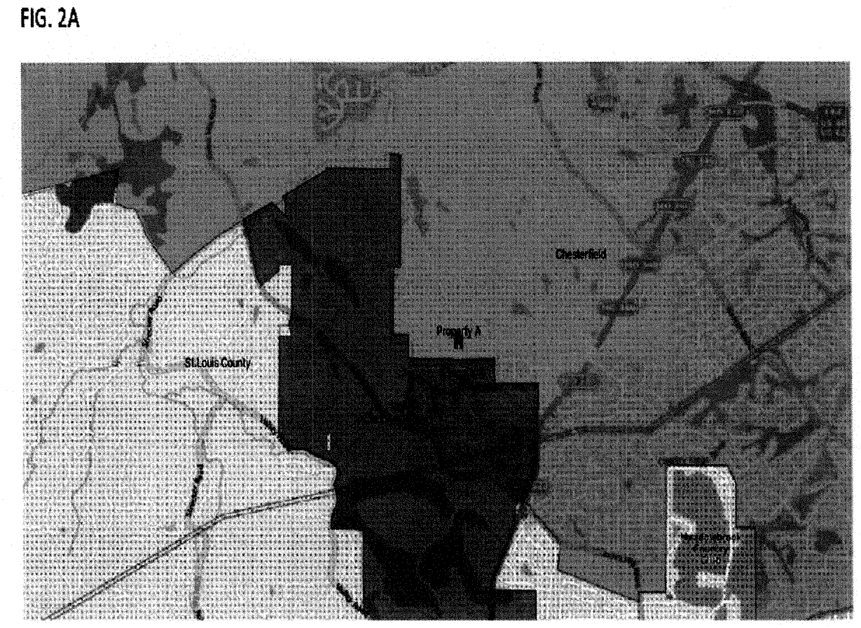

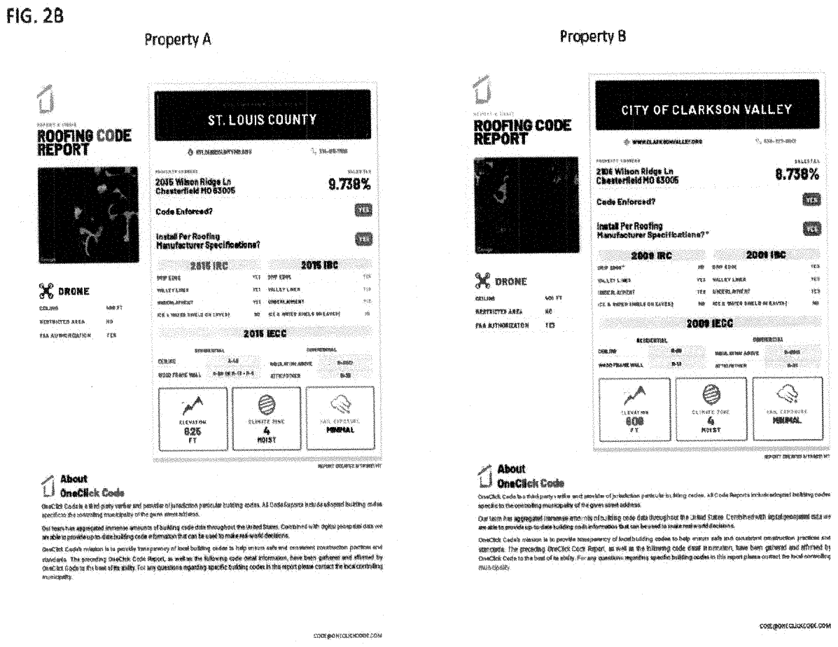

Referring to FIG. 2A, Property A has a U.S. Postal Service address of “2035 Wilson Ridge Ln, Chesterfield, Mo. 63005”. Property B has a U.S. Postal Service address of “2106 Wilson Ridge Ln, Chesterfield, Mo. 63005”. Property A is within the city of Chesterfield, while Property B, just a few houses down from Property A and on the same street, is within the city of Clarkson Valley, even though the assigned city by the U.S. Postal Service for Property B is Chesterfield. The present invention is able to discern that although the U.S. Postal Service addresses for Property A and Property B show “Chesterfield”, the jurisdiction having building code authority for Property B is the City of Clarkson Valley while the jurisdiction having building code authority for Property A is St. Louis County.

Referring to FIG. 2B, a screen shot of the present inventions output showing the differences in building codes between St. Louis County (the municipality having building code jurisdiction over Property A) and the City of Clarkson Valley (the municipality having building code jurisdiction over Property B).

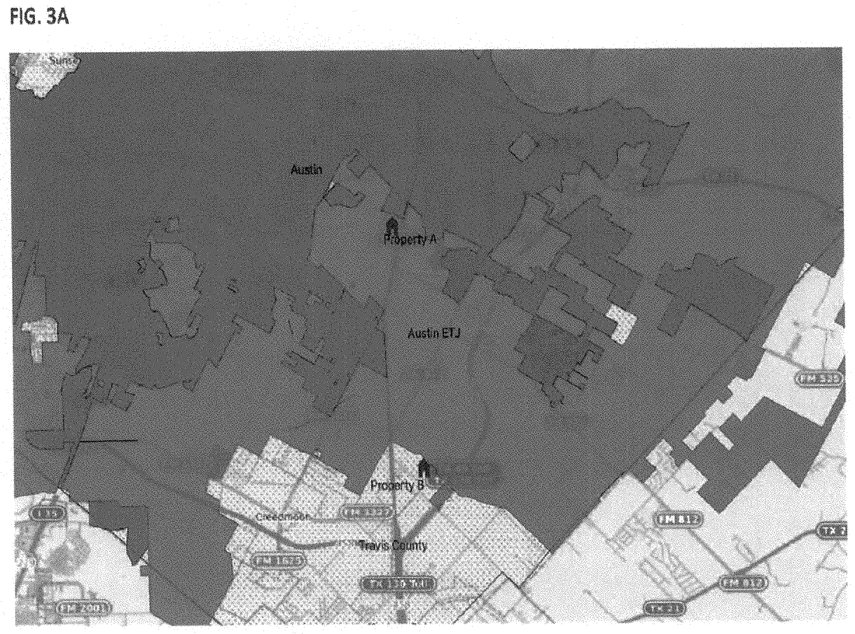

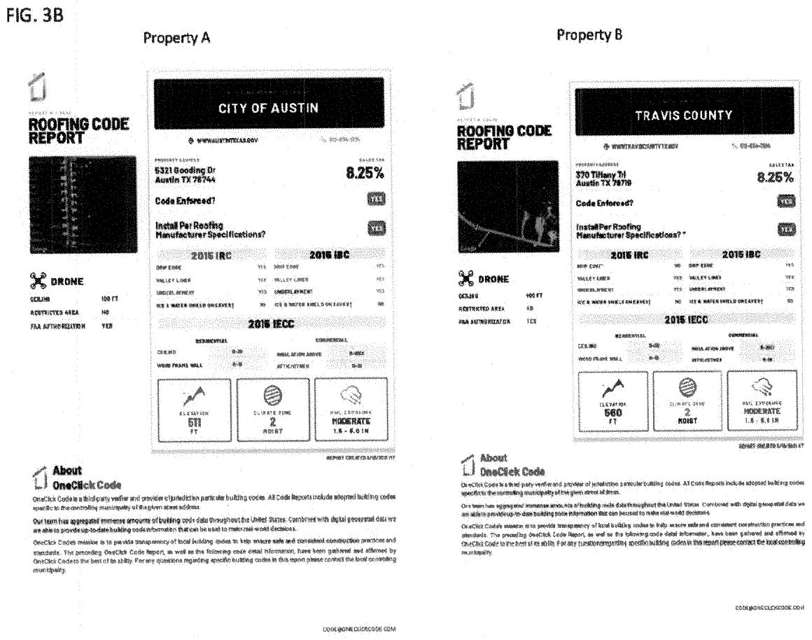

Referring to FIG. 3A, Property A has a U.S. Postal Service address of “5321 Gooding Dr, Austin, Tex. 78744”. Property A is outside the legal municipal boundaries of Austin, Tex. and within unincorporated Travis County. However, Property A is within the Extra-Territorial Jurisdiction of Austin, Tex. and thus under their building code jurisdiction. Property B has a U.S. Postal Service address of “370 Tiffany Trail, Austin, Tex. 78719”. Property B is outside the legal municipal boundaries of Austin, Tex. and within unincorporated Travis County and just outside the Extra-Territorial Jurisdiction of Austin, Tex. Property B is under the building code jurisdiction of Travis County.

Referring to FIG. 3B, a screen shot of the present inventions output showing the differences in building codes between the City of Austin (the municipality having building code jurisdiction over Property A) and the Travis County (the municipality having building code jurisdiction over Property B).

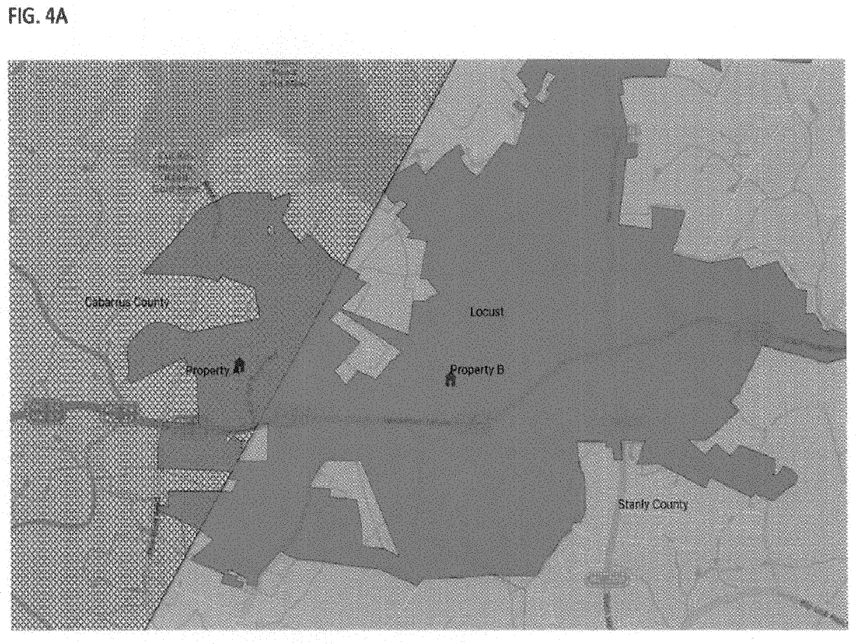

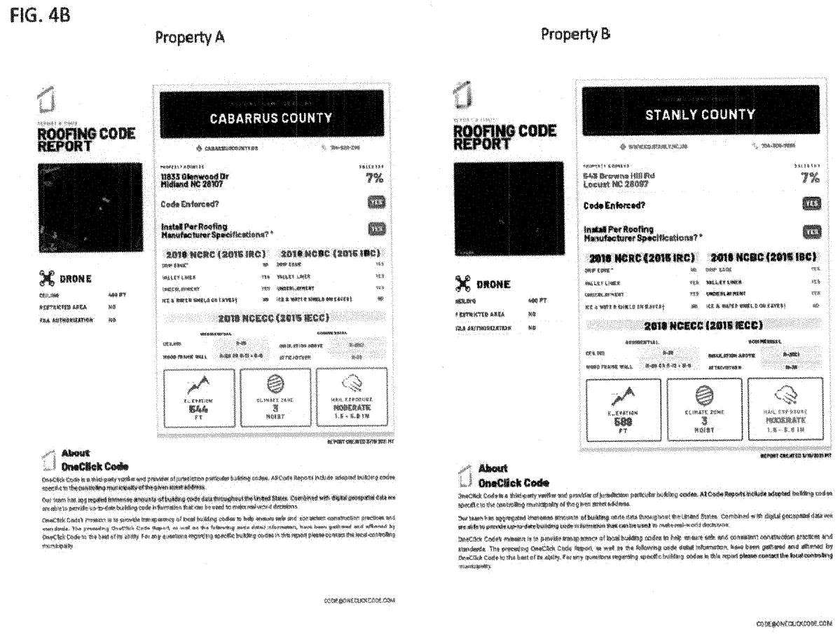

Referring to FIG. 4A, Property A has a U.S. Postal Service address of “11833 Ulenwood Dr, Midland, N.C. 28107”. Although the assigned city by the US Post Office for Property A is Midland, Property A is actually within the City of Locust, N.C. Property B has a U.S. Postal Service address of “543 Browns Hill Rd, Locust N.C. 28097”. The City of Locust, NC defers their building code authority to the county level. As displayed on the map in FIG. 4A, the City of Locust is within two different counties, Cabarrus County and Stanly County. The authority having jurisdiction over the building code is thus dependent on what county a property resides. Property A, being in Cabarrus County, is under their jurisdiction, while Property B, being in Stanly County is under its jurisdiction. The present invention is able to discern which county each property is in as well as determine that the City of Locust defers their building code authority to the county level.

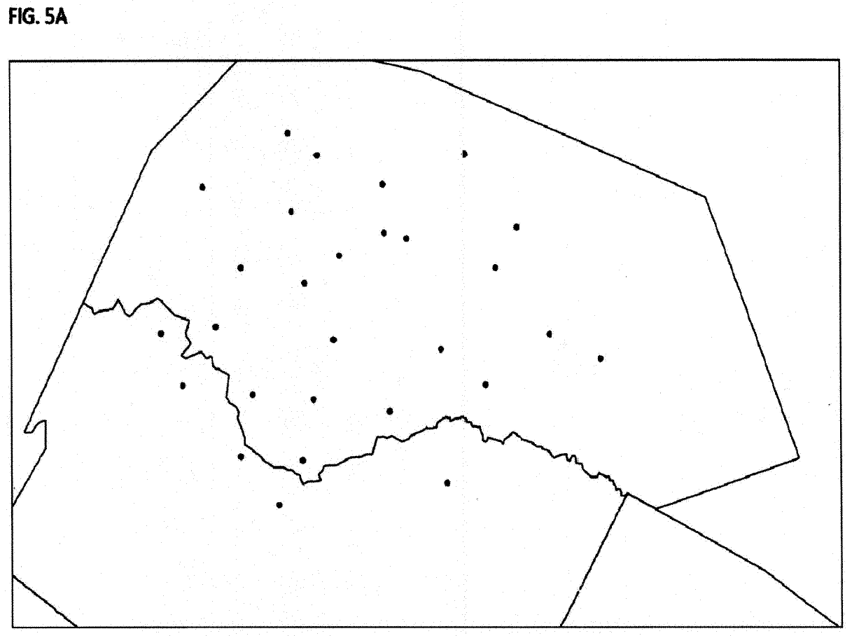

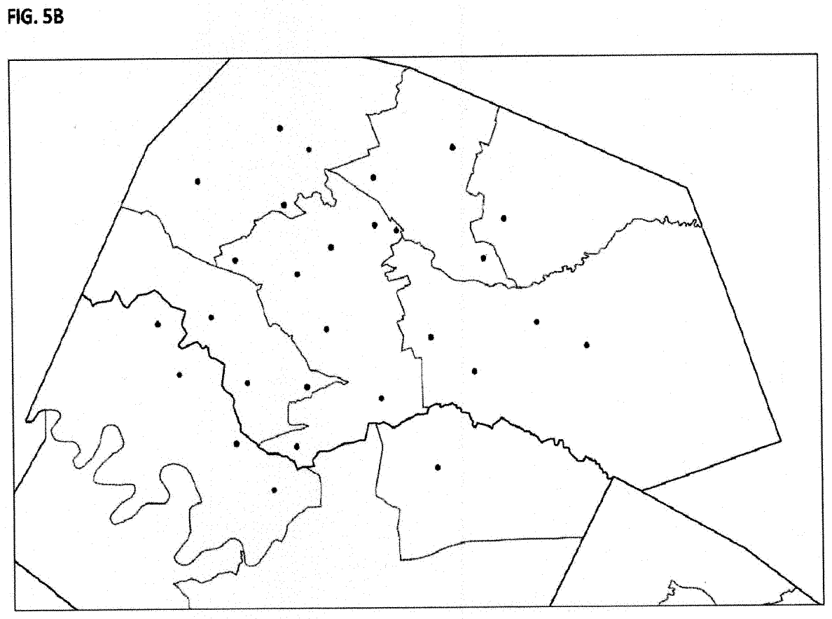

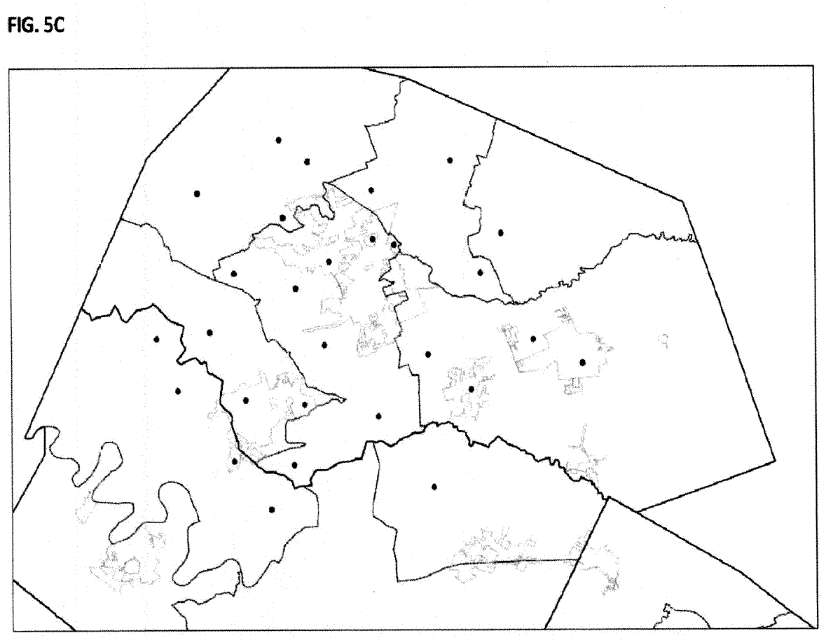

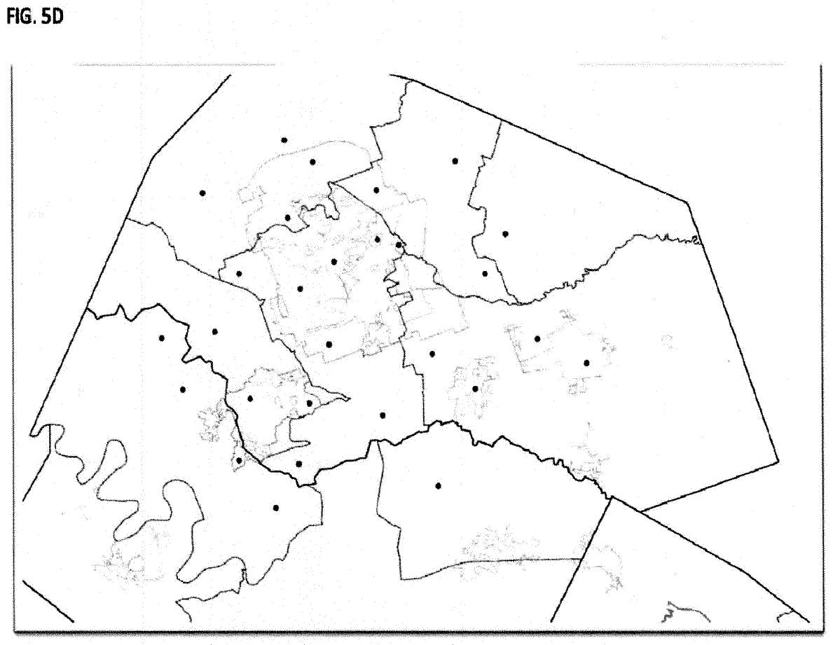

Referring to FIG. 5A, various points, representing residential properties, are displayed on a map within county boundaries drawn with a black line. This simplistic view shows which county could potentially have jurisdiction over various properties based on the physical location of a represented property being within the boundaries of a given county.

Referring to FIG. 5B, the same points and county boundaries from FIG. 5A are shown, with the additional, boundaries of county subdivisions drawn in red. This additional view shows how the various properties could be within the jurisdiction of a given county as well as within a given county subdivision.

Referring to FIG. 5C, the same points, county boundaries and county subdivision boundaries from FIG. 5B are shown, with the additional boundaries of cities drawn in yellow. This additional view shows how the various properties could be within the jurisdiction of a given county, a given county subdivision, as well as within a given city.

Referring to FIG. 5D, the same points, county boundaries, county subdivision boundaries, and city boundaries from FIG. 5C are shown, with the additional boundaries of Extra-Territorial Jurisdictions and special districts drawn in green. This additional view shows how the various properties could be within the jurisdiction of a given county, a given county subdivision, a given city, as well as within a given Extra-Territorial Jurisdiction or special district.

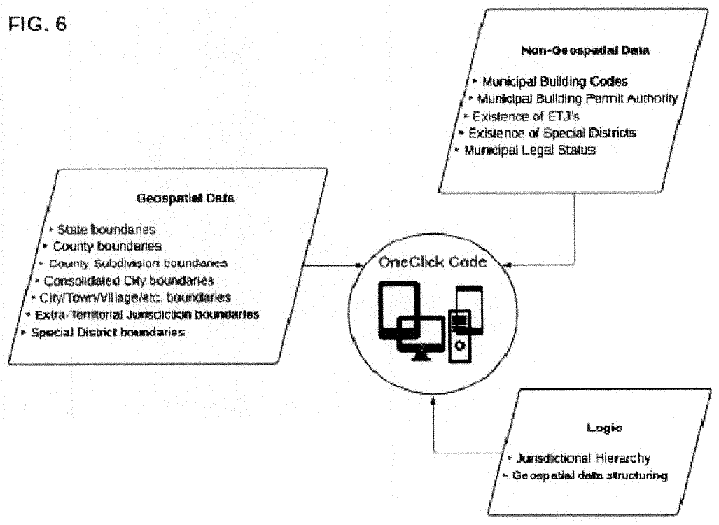

FIG. 6 provides detail around the types of data, geospatial, non-geospatial, and the logic used in the invention. Geospatial data connects a property's geographical location with the various municipal jurisdictions that contain the property. The non-geospatial data provides contextual data related to the various municipal jurisdictions that might contain the property. The logic handles the hierarchy of the various municipal jurisdictions. The hierarchy involves the common situation in which multiple jurisdictions contain property and deciphering which of those jurisdictions has the final building code and building permit authority.

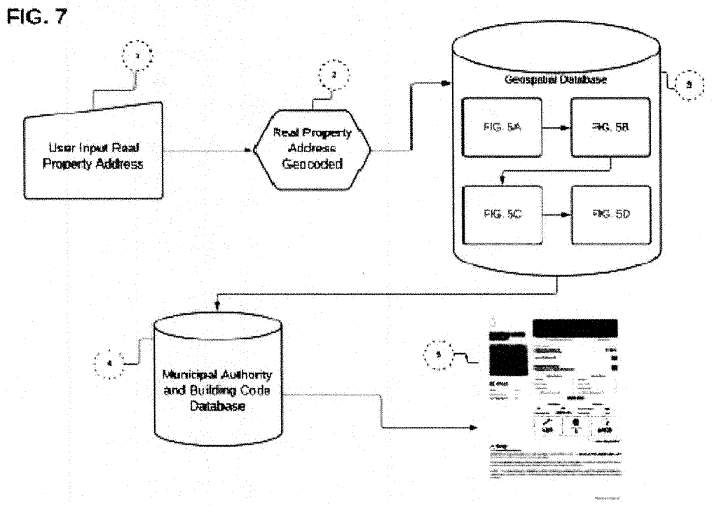

FIG. 7 shows an overview of the steps taken to determine jurisdictional authority for a specific address and retrieve and display the applicable building code authority and the enforced building codes. In Step 1 a specific property address is input. Step 2 utilizes the geospatial database and determines all the jurisdictions that contain the specific property address from Step 1, exemplified through FIG. 5A, FIG. 5B, FIG. 5C and FIG. 5D. Once all the appropriate jurisdictions are determined, Step 3 queries each of those jurisdictions against the Municipal Authority and Building Code Database to determine, through hierarchical logic, which of the jurisdictions detected in FIG. 5A, FIG. 5B, FIG. 5C and FIG. 5D have the authority over the specific property input from Step 1 to issue building permits and what the building codes are for that specific authority.

The invention claimed is:

1. A computer-implemented method to automatically identify any and all municipal jurisdictions containing real property and determine which of those previously identified jurisdictions has the authority to enforce adopted building codes and issue building permits comprising the steps of:
(a) importing geographical information system spatial data into a Geospatial Database comprising municipal jurisdictional boundaries;
(b) importing data related to building codes and the authority to issue building permits for jurisdictions from all municipal governments within the United States into a Master Database;
(c) correlating said jurisdictions from the Geospatial Database with said building codes and said authorities to issue building permits from the Master Database;
(d) retrieving data comprising building codes and authority to issue building permits for one or more jurisdictions from the Master Database; and
(e) creating an output comprising a report and API.

2. The method of claim 1 wherein said municipal jurisdictions within the Geospatial Database comprise state jurisdictions, county jurisdictions, county subdivision jurisdictions, city or place jurisdictions, special district jurisdictions, and extra-territorial jurisdictions.

3. The method of claim 1 further comprising the steps of compiling building code information and the municipal authority to issue building permits for each of said jurisdictions within the Master Database, where:
(a) each municipality within the 50 United States and Washington, D.C. are contacted and researched;
(b) all data gathered from each municipality is collected and stored within the Master Database;
(c) each municipality within the Master Database is determined to either:
i. have the authority to issue building permits and enforce building codes within its jurisdictional boundaries;
ii. defer to another municipality to issue building permits and enforce building codes within its jurisdictional boundaries;
iii. elect to have no building codes and thus not issue building permits within its jurisdictional boundaries; or
iv. some combination of the above possibilities
(d) each municipality within the Master Database that has adopted building codes has a historical record of past building codes, current building codes, and future building codes;
(e) each municipality has a unique geographic identifier.

4. The method of claim 1 in which a user input property address is geocoded into a coordinate pair and plotted by way of a point-in-polygon algorithm that determines which polygon(s) or multipolygon(s) contain said point, where:
(a) a polygon is defined as a plane two-dimensional figure that is described by a finite number of straight-line segments connected to form a closed polygonal chain;
(b) a multipolygon is defined as a collection of polygons that do not intersect;
(c) a coordinate pair is a pair of numeric values representing a given point's latitude and longitude values;
(d) the segments of a polygonal circuit or multipolygon are called its edges or sides and the points where the two edges meet are the polygon's vertices, where;
(e) each polygon or multipolygon may be contained within another polygon or multipolygon, where;
(f) the points lying on the edges of a polygon or multipolygon are considered to be inside the polygon or multipolygons.

5. The method of claim 4 where the collection of polygons and multipolygons that contain the coordinate pair are determined utilizing the Geospatial Database, where;
(a) each polygon or multipolygon is representative of a state, county, township, city, special region, or extra territorial jurisdiction where;
(b) each polygon or multipolygon contains metadata that includes a unique geographic identifier.

6. The method of claim 5 correlates the collection of polygons or multipolygons representative of municipal jurisdictions from the Geospatial Database to the Master Database by way of the unique geographic identifier contained in the metadata of each polygon or multipolygon, where;
(a) the Master Database utilizes logic to run queries that identifies which of the said municipal jurisdictions have or do not have building codes or the authority to issue building permits;
(b) determining, based on a municipality's legal government status and its municipal deference per claim 4, which of the municipal jurisdictions that contain said property, has ultimate authority over the adoption and enforcement of building codes and the authority to issue building permits.

7. The method of claims 4, 5, and 6 in which the municipal jurisdiction having authority to adopt and enforce building codes for said property is determined and that municipality's building codes are displayed.
